(19) United States
(12) Patent Application Publication
(10) Pub. No.: US 2026/0209068 A1
(43) Pub. Date: Jul. 23, 2026

(54) DOPED MANGANESE-RICH CATHODE ACTIVE MATERIALS AND METHODS THEREOF

(71) Applicant: Tesla, Inc., Austin, TX (US)

(72) Inventors: Andrew Phillip Ulvestad, Oakland, CA (US); Derrick Charles Sokol, Santa Clara, CA (US); Vineet Haresh Mehta, Mountain View, CA (US)

(21) Appl. No.: 19/140,938

(22) PCT Filed: Jan. 2, 2024
(86) PCT No.: PCT/US2024/010023

§ 371 Date: Jun. 18, 2025

Related U.S. Application Data
(60) Provisional application No. 63/478,465, filed on Jan. 4, 2023.

(51) Int. Cl. C01G 45/1242; H01M 4/02; H01M 4/04; H01M 4/505

(52) U.S. Cl. CPC C01G 45/1242; H01M 4/0404; H01M 4/505; C01P 2002/52; C01P 2006/40; H01M 2004/028

(57) ABSTRACT

Doped manganese-rich cathode active materials, and methods of manufacture, are described. The doped manganese-rich cathode active materials enable energy storage devices with improved performances, including but not limited to improved cycle life and capacity retention.

### INCORPORATION BY REFERENCE TO ANY PRIORITY APPLICATIONS

Any and all applications for which a foreign or domestic priority claim is identified in the Application Data Sheet or PCT Request as filed with the present application are hereby incorporated by reference under 37 CFR 1.57, and Rules 4.18 and 20.6. This application claims priority to U.S. Provisional Application No. 63/478,465, entitled DOPED MANGANESE-RICH CATHODE ACTIVE MATERIALS AND METHODS THEREOF, filed on Jan. 4, 2023, which is incorporated by reference in its entirety herein.

### BACKGROUND

### Field

The present disclosure relates generally to energy storage devices, and specifically to cathode active materials for lithium-ion batteries and processes for forming the same.

### Description of the Related Art

Electrochemical energy storage systems are widely used to provide power to electronic, electromechanical, electrochemical, and other useful devices. Lithium-ion batteries are one of the most common examples of electrochemical energy storage systems, and the prevalence of lithium-ion batteries is due to their higher energy density when compared to other electrochemical energy storage systems. During the last decade, the use of lithium-ion batteries has expanded from consumer electronics to other areas including the automotive industry. A lithium-ion battery consists of four main components: a cathode electrode, anode electrode, electrolyte, and separator, and at least some of the success of lithium-ion batteries may be attributed to the development of high-energy density electrodes.

Presently, there are a small number of cathode active materials which are known or have been investigated for use in cathode electrodes for lithium-ion batteries, for example in the automotive industry. Examples of cathode active materials include manganese-rich cathode active materials such as LiMn₂O₄. LiMn₂O₄ is a low-cost, high voltage and environment friendly cathode active material with moderate energy density. These attractive characteristics make spinel LiMn₂O₄ a good candidate for large-scale batteries for electric vehicle (EV) and hybrid electric vehicle (HEV) applications. However, LiMn₂O₄ currently is not widely used as a cathode active material for batteries requiring long cycle life due to capacity fading caused by Mn dissolution and subsequent cell degradation, especially at elevated temperature. The capacity may be faded after less than 50 cycles. Accordingly, there is a need for the development of improved manganese-rich cathode active materials with improved cycle lives.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

In a first aspect, a doped cathode active material is provided. The doped cathode active material includes a compound having the chemical formula Li₍₁₊ₐ₎M_{b}Mn_{(2-c)}M′_{c}O_{(4-d)}Xₑ, where M is a metal dopant, M′ is a Group 13 dopant, X is an anion dopant, a is a value from 0 to 0.2, b is a value from 0.01 to 0.1, c is a value from 0 to 0.2, d is a value from 0 to 0.04, and e is a value from 0.001 to 0.04.

In some embodiments, M is selected from the group consisting of K, Na, Mg, Sr, and combinations thereof. In some embodiments, X is a halogen dopant. In some embodiments, X is selected from the group consisting of F, Cl, SO₄, and combinations thereof. In some embodiments, M′ is selected from the group consisting of B, Al, and combinations thereof. In some embodiments, M′_{c} is AlₓB_{y}, where c=x+y. In some embodiments, the compound has a chemical formula Li₍₁₊ₐ₎Na_{b}Mn_{(2-c)}AlₓB_{y}O_{(4-d)}Fₑ. In some embodiments, the compound has a chemical formula Li_{1.05}Na_{0.05}Mn_{1.82}Al_{0.15}B_{0.03}O_{3.98}F_{0.02}.

In some embodiments, a cathode electrode film including the doped cathode active material and a binder is provided. In some embodiments, the cathode electrode film is disposed over a current collector to form a cathode electrode. In some embodiments, an energy storage device includes the cathode electrode, a separator, an anode electrode, an electrolyte, and a housing, where the cathode electrode, the separator, and the anode electrode are positioned within the housing. In some embodiments, the energy storage device is a battery.

In a second aspect, a process for forming a doped cathode active material is provided. In some embodiments, the process includes combining a manganese source, a dopant material, and a lithium source to form a doped cathode active material mixture, and heating the doped cathode active material mixture to form a doped cathode active material. In some embodiments, the combining comprises mixing the manganese source, the dopant material, and the lithium source.

In some embodiments, the lithium source is selected from the group consisting of LiOH, Li₂CO₃, LiF, LiCl, and combinations thereof. In some embodiments, the manganese source is selected from the group consisting of Mn₃O₄, MnF₂, and combinations thereof. In some embodiments, the dopant material is selected from the group consisting of a Group 13 dopant source, a metal dopant source, an anion dopant source, and combinations thereof. In some embodiments, the anion dopant source is selected from the group consisting of MnF₂, MgF₂, MgCl₂, AlF₃, SrF₂, NaF, NaCl, LiF, LiCl, KCl, K₂SO₄, and combinations thereof. In some embodiments, the metal dopant source is selected from the group consisting of KCl, K₂SO₄, NaF, NaCl, Na₂CO₃, MgF₂, MgCO₃, Mg(OH)₂, SrF₂, MgCl₂, and combinations thereof. In some embodiments, the Group 13 dopant source is selected from the group consisting of H₃BO₃, Al(OH)₃, and combinations thereof. In some embodiments, the dopant material comprises H₃BO₃, Al(OH)₃, MnF₂ and Na₂CO₃.

In some embodiments, the doped cathode active material mixture is heated to about 700° C.-900° C. In some embodiments, the doped cathode active material mixture is heated for about 4-6 hours in ambient air.

In another aspect, a process of forming a doped cathode active material is provided. In some embodiments, the process includes combining a manganese source, a first dopant material, and a lithium source to form a first doped cathode active material mixture, heating the first doped cathode active material mixture at a first temperature, combining the heated first doped cathode active material mixture with a second dopant material to form a second doped cathode active material mixture, and heating the second doped cathode active material mixture at a second temperature different from the first temperature to form the doped cathode active material. In some embodiments, combining the manganese source, the first dopant material, and the lithium source comprises mixing the manganese source, the first dopant material, and the lithium source. In some embodiments, combining the heated first doped cathode active material mixture with the second dopant material comprises mixing the heated first doped cathode active material mixture with the second dopant material. In some embodiments, the process further comprises sieving the heated second doped cathode active material mixture.

In some embodiments, the first dopant material is selected from the group consisting of a Group 13 dopant source, an anion dopant source, and combinations thereof. In some embodiments, the second dopant material comprises a metal dopant source. In some embodiments, the second temperature is lower than the first temperature. In some embodiments, the first temperature is about 700° C.-900° C. In some embodiments, the second temperature is about 600° C.-800° C. In some embodiments, the heated second doped cathode active material mixture is sieved to form the second doped cathode active material mixture.

### BRIEF DESCRIPTION OF THE DRAWINGS

These and other features, aspects, and advantages of the present disclosure are described with reference to the drawings of certain embodiments, which are intended to illustrate certain embodiments and not to limit the invention.

FIG. 1 is a flow diagram showing an example of a single-step baking method for fabricating a doped cathode active material, according to some embodiments.

FIG. 2 is a flow diagram showing an example of a two-step baking method for fabricating a doped cathode active material, according to some embodiments.

FIG. 3A is a plot showing the cycle performance of a full cell with a cathode comprising doped manganese-rich cathode active materials formed with a single-step baking method, according to some embodiments.

FIG. 3B is a plot showing the normalized cycle performance of a full cell with a cathode comprising doped manganese-rich cathode active materials formed with a single-step baking method, according to some embodiments.

FIG. 4A is a plot showing the cycle performance of a full cell with a cathode comprising doped manganese-rich cathode active materials formed with a two-step baking method, according to some embodiments.

FIG. 4B is a plot showing the normalized cycle performance of a full cell with a cathode comprising doped manganese-rich cathode active materials formed with a two-step baking method, according to some embodiments.

FIG. 5A is a plot showing the cycle performance of a full cell with a cathode comprising doped manganese-rich cathode active materials and a control cathode active material, according to some embodiments.

FIG. 5B is a plot showing the normalized cycle performance of a full cell with a cathode comprising doped manganese-rich cathode active materials and a control cathode active material, according to some embodiments.

### DETAILED DESCRIPTION

Provided herein are various embodiments of doped manganese-rich cathode active materials with improved capacity retention and prolonged cycle life, and methods for preparing the doped manganese-rich cathode active materials. Doping of the manganese-rich cathode active materials may aid in reducing the manganese dissolution from the Mn-rich cathode active material, such as the lithium manganese oxide spinel (“LiMn₂O₄”), and reduce the subsequent cell degradation and capacity fading. In some embodiments, the improved doped manganese-rich cathode active materials described herein may aid in reducing manganese dissolution from the doped manganese-rich cathode active materials, and thereby improve cycle lifetimes and capacity retention in energy storage devices.

In certain embodiments, the doped manganese-rich cathode active material may include a dopant material. In some embodiments, the dopant material is selected from a metal dopant (M), Group 13 dopant (M′), an anion dopant (X), and combinations thereof. In some embodiments, the dopant material comprises a metal dopant selected from sodium (Na), magnesium (Mg), potassium (K), strontium (Sr), and combinations thereof. In some embodiments, the dopant material comprises an anion dopant selected fluorine (F), chlorine (Cl), sulfate (SO₄²⁻) and combinations thereof. In some embodiments, the anion dopant is a halogen dopant. In some embodiments, the dopant material comprises a Group 13 dopant selected boron (B), aluminum (Al) and combinations thereof. In certain embodiments, the doped manganese-rich cathode active materials may have the general formula Li₍₁₊ₐ₎M_{b}Mn_{(2-c)}M′_{c}O_{(4-d)}Xₑ or LiM_{b}Mn₂M′_{c}O₄Xₑ, wherein M is a metal dopant, M′ is a Group 13 dopant element, X is an anion dopant. “a”, “b”, “c,” “d” and “e” are values which create a neutrally charged dopant material.

Such doped manganese-rich cathode active materials are described and may be prepared by the processes described herein.

### A. Doped Manganese-Rich Cathode Active Material

Cathode active materials (e.g., lithium manganese oxide spinel, LiMn₂O₄) with high manganese content (“manganese-rich”) may include a dopant to improve the performance of cathode electrodes. In some embodiments, the manganese-rich cathode active material comprises LiMn₂O₄. In some embodiments, the doped manganese-rich cathode active material comprises lithium (Li), manganese (Mn), an anion dopant and oxygen (O). In some embodiments, the doped manganese-rich cathode active material comprises lithium (Li), manganese (Mn), a metal dopant (M) and oxygen (O). In some embodiments, the doped manganese-rich cathode active material comprises lithium (Li), manganese (Mn), a metal dopant (M), an anion dopant and oxygen (O). In some embodiments, the doped manganese-rich cathode active material further comprises a Group 13 dopant.

In some embodiments, the doped manganese-rich cathode active materials are of the general formula Li₍₁₊ₐ₎M_{b}Mn_{(2-c)}M′_{c}O_{(4-d)}Xₑ, wherein M is a metal dopant, M′ is a Group 13 dopant, X is an anion dopant, and “a”, “b”, “c,” “d” and “e” are values which create a neutrally charged dopant material.

In some embodiments, “a” is, is about, is at most, or is at most about, 0, 0.001, 0.005, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29 or 0.3, or any range of values therebetween. For example, in some embodiments, “a” is a numerical value from 0 to 0.3, from 0 to 0.02, from 0.001 to 0.2, or from 0.01 to 0.02.

In some embodiments, the metal dopant (M) is selected from sodium (Na), magnesium (Mg), potassium (K), strontium (Sr), and combinations thereof. In some embodiments, “b” is, is about, is at most, or is at most about, 0, 0.001, 0.005, 0.01, 0.02, 0.025, 0.03, 0.04, 0.05, 0.06, 0.07, 0.08, 0.09, 0.0995, 0.1, 0.11, 0.12, 0.13, 0.14 or 0.15, or any range of values therebetween. For example, in some embodiments, “b” is a numerical value from 0 to 0.15, from 0.001 to 0.10, from 0.01 to 0.05, from 0.005 to 0.25, or from 0.02 to 0.1.

In some embodiments, the Group 13 dopant (M′) is selected from the group consisting of boron (B), aluminum (Al), and combinations thereof. In some embodiments, the Group 13 dopant M′_{c} comprises AlₓB_{y}, where c=x+y. In some embodiments, “x” is, is about, is at most, or is at most about 0, 0.001, 0.005, 0.01, 0.02, 0.04, 0.06, 0.08, 0.10, 0.12, 0.14, 0.16, 0.18, 0.20, 0.22, 0.24, 0.26, 0.28 or 0.3, or any range of values therebetween. For example, in some embodiments, “x” is a numerical value from 0 to 0.3, from 0.001 to 0.2, or from 0.05 to 0.02. In some embodiments, “y” is, is about, is at most, or is at most about, 0, 0.001, 0.005, 0.01, 0.02, 0.03, 0.04, 0.05, 0.06, 0.07, 0.08, 0.09, 0.0995 or 0.1, or any range of values therebetween. For example, in some embodiments, “y” is a numerical value from 0 to 0.1, from 0.001 to 0.05, or from 0.002 to 0.05. In some embodiments, “c” is, is about, 0, 0.001, 0.005, 0.01, 0.02, 0.05, 0.1, 0.15, 0.2, 0.25, 0.3, 0.35 or 0.4, or any range of values therebetween. For example, in some embodiments, “c” is a numerical value from 0.001 to 0.4, from 0.001 to 0.03, or from 0.001 to 0.02.

In some embodiments, “d” is, is about, is at most, or is at most 0, 0.0001, 0.001, 0.005, 0.01, 0.015, 0.02, 0.025, 0.03, 0.035, 0.04, or any range of values therebetween. For example, in some embodiments, “d” is a numerical value from 0 to 0.04, from 0.0001 to 0.03, or from 0.01 to 0.04, or from 0.01 to 0.03. In some embodiments, the anion dopant (X) is selected from the group consisting of fluorene (F), chlorine (CI), sulfate (SO₄²⁻), and combinations thereof. In some embodiments, the anion dopant is a halogen dopant. In some embodiments, the halogen dopant is selected from the group consisting of fluorene (F), chlorine (CI), and combinations thereof. In some embodiments, “e” is, is about, is at most, or is at most about 0, 0.0001, 0.001, 0.005, 0.01, 0.015, 0.02, 0.025, 0.03, 0.035, 0.04, or any range of values therebetween. For example, in some embodiments, “e” is a numerical value from 0.0001 to 0.04, from 0.0001 to 0.03, or from 0.01 to 0.04, or from 0.01 to 0.03.

In some embodiments, the doped manganese-rich cathode active materials are of the formula Li₍₁₊ₐ₎Na_{b}Mn_{(2-c)}AlₓB_{y}O_{(4-d)}Fₑ or LiNa_{b}Mn₂AlₓB_{y}O₄Fₑ. Values for “a,” “b,” “c,” “x,” “y,” “d” and/or “e” are discussed herein. In some embodiments, the doped manganese-rich cathode active material comprises a compound having a chemical formula of, or about, Li_{1.05}Na_{0.05}Mn_{1.82}Al_{0.15}B_{0.03}O_{3.98}F_{0.02}.

### B. Processes of Forming Doped Manganese-Rich Cathode Active Material

The doped manganese-rich cathode active material is formed through a thermal reaction (e.g., baking) of precursor ingredients, including a lithium source, a dopant material, and a manganese source in various ordering and processing steps. In some embodiments, a single-step baking method or a two-step baking method is used to form the doped manganese-rich cathode active material disclosed herein.

In some embodiments, the method further includes sieving after heating. In some embodiments, the process further includes destructing the doped manganese-rich cathode active material as described. In some embodiments, destructing comprises a step selected from the group consisting of: crushing, milling, and combinations thereof. In some embodiments, the process includes treating the doped manganese-rich cathode active material described herein. In some embodiments, treating comprises a step selected from the group consisting of: sieving, washing, filtering, drying, coating, and combinations thereof. In some embodiments, the manganese source is selected from the group consisting of: manganese oxide, MnF₂, and combinations thereof. In some embodiments, the manganese source comprises manganese oxide, such as Mn₃O₄. In some embodiments, the lithium source includes a lithium salt. In some embodiments, the lithium salt is selected from the group consisting of: LiOH, H₂O, Li₂CO₃, and combinations thereof. In some embodiments, the lithium source is Li₂CO₃.

In some embodiments, the dopant material is selected from the group consisting of: a Group 13 dopant source, a metal dopant source, an anion dopant source, and combinations thereof. In some embodiments, the dopant material is the combination of a Group 13 dopant source, a metal dopant source and an anion dopant source. In some embodiments, the anion dopant source is selected from the group consisting of: MnF₂, MgF₂, MgCl₂, AlF₃, SrF₂, NaF, NaCl, LiF, LiCl, KCl, K₂SO₄, and combinations thereof. In some embodiments, the anion dopant source is a halogen dopant source. In some embodiments, the halogen dopant source is selected from the group consisting of: MnF₂, MgF₂, MgCl₂, AlF₃, SrF₂, NaF, NaCl, LiF, LiCl, KCl, and combinations thereof. In some embodiments, the halogen dopant source is MnF₂. In some embodiments, the metal dopant source is selected from the group consisting of: KCl, K₂SO₄, NaF, NaCl, Na₂CO₃, MgF₂, MgCO₃, Mg(OH)₂, SrF₂, MgCl₂, and combinations thereof. In some embodiments, the metal dopant source is Na₂CO₃. In some embodiments, the Group 13 dopant source is selected from the group consisting of: H₃BO₃, Al(OH)₃, and combinations thereof. In some embodiments, the Group 13 dopant source is H₃BO₃ and Al(OH)₃.

In some embodiments, the molar ratio of the metal dopant source, Group 13 dopant source, and anion dopant source in the precursor ingredient mixture before the final baking step is calculated based on the intended formula of the cathode active material. In some embodiments, the precursor ingredient mixture before the final baking step is the doped cathode active material mixture according to the single-baking method, as discussed herein. In some embodiments, the precursor ingredient mixture before the final baking step is the second doped cathode active material mixture prior to the second baking step according to a two-step baking method, as discussed herein.

In some embodiments, the molar ratio of the lithium:manganese in the precursor ingredient mixture before the final baking step is, or is about, 1:1.6, 1:1.65, 1:1.7, 1:75, 1:1.8, 1:1.85, 1:1.9, 1:2, 1:2.05, 1:2.1, 2:2.15, 1:2.2, or any range of values therebetween. In some embodiments, the precursor ingredient mixture before the final baking step comprises, comprises about, comprises at most, or comprises at most about 20 wt. %, 25 wt. %, 30 wt. %, 35 wt. %, 40 wt. % 45 wt %, or 50 wt % of a lithium source, or any range of values therebetween.

In some embodiments, the precursor ingredient mixture before the final baking step comprises, comprises about, comprises at most, or may comprise at most about 1 mol. %, 2 mol. %, 3 mol %, 4 mol %, 5 mol %, 6 mol %, 7 mol %, 8 mol. %, 9 mol %, 10 mol. %, 12 mol. %, 15 mol. %, 17 mol. %, 20 mol. %, 22 mol. %, 25 mol. %, 20 mol. %, 27 mol. %, 35 mol. %, 40 mol. %, 45 mol % or 50 mol. % of a dopant material, or any range of values therebetween.

In some embodiments, the precursor ingredient mixture before the final baking step comprises, comprises about, comprises at most, or comprises at most about 0.1 mol. %, 0.125 mol. %, 0.25 mol. %, 0.5 mol. %, 0.75 mol. %, 1 mol. %, 1 mol. %, 2 mol. %, 3 mol. %, 4 mol. % or 5 mol. % of an anion dopant source (e.g., halogen dopant source), or any range of values therebetween. For example, in some embodiments, the precursor ingredient mixture before the final baking step comprises 0.1 to 5 mol. %, 1 to 5 mol. %, or 1 to 2 mol. % of the anion dopant source. In some embodiments, the amount of the anion dopant source (e.g., MnF₂) is in a range that would not substantially promote the formation of Mn³⁺ during producing the doped Mn-rich cathode active material or lithiation and delithiation processes, and yet achieve the improved performance and prolonged cycle life.

In some embodiments, the precursor ingredient mixture before the final baking step comprises, comprises about, comprises at most, or comprises at most about 0.1 mol. %, 0.5 mol. %, 1 mol. %, 2 mol. %, 3 mol. %, 4 mol. %, 5 mol. %, 7 mol. %, 9 mol. % or 10 mol. % of a metal dopant source, or any range of values therebetween. For example, in some embodiments, the precursor ingredient mixture before the final baking step comprises 0.1 to 10 mol. %, 1 to 10 mol. %, or 1 to 5 mol. % of the anion dopant source. In some embodiments, the amount of the metal dopant source such as Na₂CO₃ is in a range that would not substantially decrease the specific capacity of the LiMn₂O₄ cathode active material and yet can achieve the improved electrochemical performance.

### 1. Single-Step Baking Method

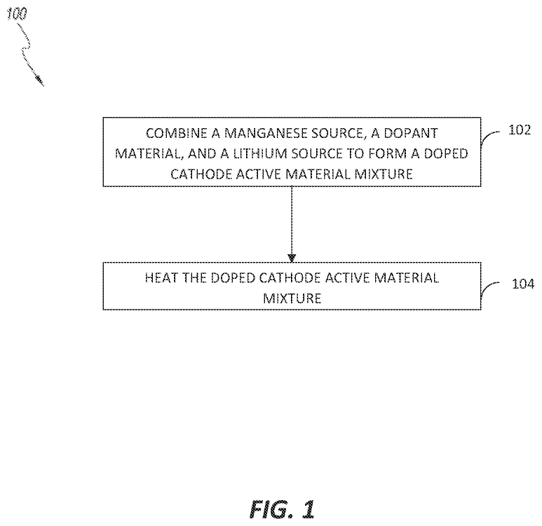

FIG. 1 shows an example of a single-step baking method 100 for fabricating a doped active material for an electrode, such as a cathode, of energy storage device. In a single-step baking method 100, according to some embodiments, in step 102, a manganese source, a dopant material, and a lithium source are combined to form a doped cathode active material mixture. In some embodiments, combining the manganese source, the dopant material, and the lithium source comprises mixing the manganese source, the dopant material, and the lithium source. In step 104, the doped cathode active material mixture is heated at a certain temperature to produce the doped manganese-rich cathode active material. In some embodiments, the single-step baking method 100 further comprises treating the heated doped cathode active material mixture to produce the doped cathode active material. In some embodiments, treating the heated doped cathode active material mixture comprises a step selected from the group consisting of: sieving, washing, filtering, drying, coating, and combinations thereof. In some embodiments, the single-step baking method 100 further comprises destructing the doped manganese-rich cathode active material. In some embodiments, destructing the doped manganese-rich cathode active material comprises a step selected from the group consisting of: crushing, milling, and combinations thereof.

In some embodiments, the doped cathode active material mixture is heated after being formed. In some embodiments, heating is performed at a temperature of, of about, of at least, or at least about, 550° C., 600° C., 625° C., 650° C., 675° C., 700° C., 725° C., 750° C., 760° C., 780° C., 800° C., 820° C., 840° C., 850° C., 860° C., 880° C., 900° C., 950° C. or 1000° C., or any range of values therebetween. For example, in some embodiments, the temperature is from 550° C. to 1000° C., from 600° C. to 900° C., or from 700° C. to 900° C., or from 750° C. to 850° C. In some embodiments, heating of the doped cathode active material mixture is performed in an oxidizing atmosphere. In some embodiments, an oxidizing atmosphere is an atmosphere comprising oxygen, for example such as air or an oxygen rich atmosphere. In some embodiments, an oxygen rich atmosphere comprises at least 21 vol % oxygen, at least 23.5 vol % oxygen or at least 25 vol % oxygen. In some embodiments, the heating is performed in ambient air. In some embodiments, the heating is performed for a duration of, of about, of at least, or at least about, 0, 1, 2, 3, 4, 5, 6, 7, 8, 9, 10, 20 or 50 hours, or any range of values therebetween.

### 2. Two-Step Baking Method

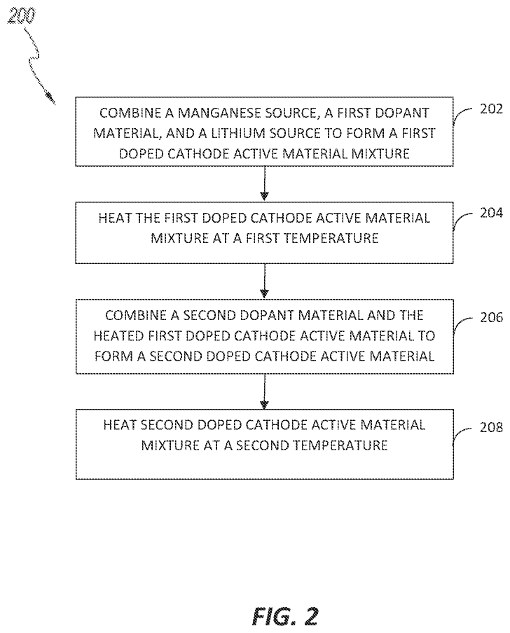

FIG. 2 shows an example of a two-step baking method 200 for fabricating a doped active material for an electrode, such as a cathode, of energy storage device. In a two-step baking method 200, according to some embodiments, in step 202, a manganese source, a first dopant material, and a lithium source are combined to form a first doped cathode active material mixture. In some embodiments, combining the manganese source, the first dopant material, and the lithium source comprises mixing the manganese source, the first dopant material, and the lithium source. In step 204, the first doped cathode active material mixture is heated at a first temperature. In step 206, the heated first doped cathode active material mixture is then combined with a second dopant material to form the second doped cathode active material mixture. In some embodiments, combining the first doped cathode active material mixture and the second dopant material comprises mixing the first doped cathode active material mixture and the second dopant material. In step 208, the second doped cathode active material mixture is heated at a second temperature to produce the doped cathode active material. In some embodiments, the two-step baking method 200 further comprises treating the heated second doped cathode active material mixture. In some embodiments, treating the heated second doped cathode active material mixture may comprise a step selected from the group consisting of: sieving, washing, filtering, drying, coating, and combinations thereof. In some embodiments, the two-step baking method 200 further comprises destructing the doped manganese-rich cathode active material. In some embodiments, destructing may comprise a step selected from the group consisting of: crushing, milling, and combinations thereof.

In some embodiments, the first dopant material is selected from the group consisting of a Group 13 dopant source, an anion dopant source, and combinations thereof. In some embodiments, the second dopant material comprises a metal dopant source.

In some embodiments, the first doped cathode active material mixture is heated after being formed at a first temperature. In some embodiments, the first temperature is, is about, is at least, or at least about, 550° C., 600° C., 625° C., 650° C., 675° C., 700° C., 725° C., 750° C., 760° C., 780° C., 800° C., 820° C., 840° C., 850° C., 860° C., 880° C., 900° C., 950° C. or 1000° C., or any range of values therebetween. For example, in some embodiments, the first temperature is from 550° C. to 1000° C., from 600° C. to 900° C., or from 700° C. to 900° C., or from 750° C. to 850° C. In some embodiments, heating of the first doped cathode active material mixture is performed in an oxidizing atmosphere. In some embodiments, an oxidizing atmosphere is an atmosphere comprising oxygen, for example such as air or an oxygen rich atmosphere. In some embodiments, an oxygen rich atmosphere comprises at least 21 vol % oxygen, at least 23.5 vol % oxygen or at least 25 vol % oxygen. In some embodiments, the heating of the first doped cathode active material mixture is performed in ambient air. In some embodiments, the heating of the first doped cathode active material mixture is performed for a duration of, of about, of at least, or at least about, 0, 1, 2, 3, 4, 5, 6, 7, 8, 9, 10, 20 or 50 hours, or any range of values therebetween.

In some embodiments, the second doped cathode active material mixture is heated after being formed at a second temperature. In some embodiments, the second temperature is, is about, is at least, or at least about, 450° C., 500° C., 525° C., 550° C., 575° C., 600° C., 625° C., 650° C., 660° C., 680° C., 700° C., 720° C., 740° C., 750° C., 760° C., 780° C., 800° C., 850° C. or 900° C., or any range of values therebetween. For example, in some embodiments, the first temperature is from 450° C. to 900° C., from 600° C. to 800° C., or from 650° C. to 750° C., or from 625° C. to 720° C. In some embodiments, heating of the second doped cathode active material mixture is performed in an oxidizing atmosphere. In some embodiments, an oxidizing atmosphere is an atmosphere comprising oxygen, for example such as air or an oxygen rich atmosphere. In some embodiments, an oxygen rich atmosphere comprises at least 21 vol % oxygen, at least 23.5 vol % oxygen or at least 25 vol % oxygen. In some embodiments, the heating of the second doped cathode active material mixture is performed in ambient air. In some embodiments, the heating of the second doped cathode active material mixture is performed for a duration of, of about, of at least, or at least about, 0, 1, 2, 3, 4, 5, 6, 7, 8, 9, 10, 20 or 50 hours, or any range of values therebetween.

In some embodiments, the second temperature is different from the first temperature. In some embodiments, the second temperature is lower than the first temperature. In some embodiments, the second temperature is about 50° C., about 100° C., about 150° C. or about 200° C., or any value therebetween, lower than the first temperature.

### C. Energy Storage Device

The doped manganese-rich cathode active materials may be used in the preparation of an electrode for an energy storage device. In some embodiments, an electrode film (e.g., doped manganese-rich electrode film) comprises a doped manganese-rich cathode active material. In some embodiments, an electrode comprises a current collector and the electrode film. In some embodiments, the electrode is a cathode electrode.

In some embodiments, an energy storage device includes an electrode as described herein. In some embodiments, the energy storage device comprises a separator, an anode electrode, a cathode electrode, and a housing, wherein the separator, anode electrode and cathode electrode are disposed within the housing and the separator is positioned between the anode and cathode electrodes. In some embodiments, an energy storage device is formed by placing a separator, an anode electrode and the cathode electrode within a housing, wherein the separator is placed between the anode electrode and the cathode electrode. In some embodiments, the energy storage device is a battery. In some embodiments, the energy storage device is a lithium-ion battery.

In some embodiments, the amount of Mn dissolution from the doped manganese-rich cathode active material disclosed herein after formation and cycling the energy storage device a certain number of cycles is less than the amount of Mn dissolution from a control manganese-rich cathode active material. In some embodiments, the amount of the Mn dissolution from the doped manganese-rich cathode active material disclosed herein is, is about, or is at least about, 10%, 15%, 20%, 25%, 30%, 35%, 40%, 45%, 50%, 55%, 60%, 70%, or 80%, or any range of values therebetween less than that from a control manganese-rich cathode active material. In some embodiments, the control manganese-rich cathode active material may be an Al and B doped LiMn₂O₄ material. In some embodiments, the control manganese-rich cathode active material has a formula of Li_{1.11}Mn_{1.88}Al_{0.088}B_{0.024}O₄.

The amount of the metal dopant source is in a range that would not substantially decrease the specific capacity of the LiMn₂O₄ cathode material and yet can achieve the improved electrochemical performance. In some embodiments, such a metal dopant source may be Na₂CO₃.

In addition, in some embodiments, at least some amount of the anion dopant remains on the surface of the formed doped Mn-rich cathode active material as a robust coating. In some embodiments, the amount of the anion dopant source is in a range that would not substantially promote the formation of Mn³⁺ which may cause addition Mn dissolution via disproportionation reaction, and yet achieve the intended flux and surface coating effect. In some embodiments, such an anion dopant source is MnF₂.

### EXAMPLES

Example embodiments of the present disclosure, including processes, materials and/or resultant products, are described in the following examples.

### Example 1—Doped Manganese-Rich Cathode Active Materials

Doped manganese-rich cathode active materials doped with various dopants were prepared through a single-step baking method and a two-step baking method as disclosed herein.

In a single-step baking method, Li₂CO₃, Mn₃O₄, Al(OH)₃, H₃BO₃, MnF₂ and Na₂CO₃ powders were mixed with a molar ratio of 0.525:0.61:0.03:0.01:0.025 to form a manganese-rich cathode active material mixture. The manganese-rich cathode active material mixture was heated to 800° C. with a heating speed of 3° C./min in air and sintered for 5 hours at 800° C. in air for 5 hours. The sintered manganese-rich cathode active material mixture was then cooled down to room temperature and then was sieved to produce the doped Mn-rich cathode active material (MnF₂/Na₂CO₃-doped Mn-rich cathode active material). The produced MnF₂/Na₂CO₃-doped Mn-rich cathode active material has a formula of Li_{1.05}Na_{0.05}Mn_{1.82}Al_{0.15}B_{0.03}O_{3.98}F_{0.02}.

Other doped manganese-rich cathode active materials such as using MgF₂, Na₂CO₃, Al(OH)₃, H₃BO₃ as the dopant materials (Mg₂F/Na₂CO₃-doped manganese-rich cathode active material) or using NaF, Na₂CO₃, Al(OH)₃, H₃BO₃ as the dopant materials (NaF/Na₂CO₃-doped manganese-rich cathode active material) were also prepared using the single-step baking method as discussed above by replacing the anion dopant source MnF₂ with MgF₂ or NaF.

In a two-step baking method, a lithium source, a manganese source, and dopant materials, except the metal dopant source, with a molar ratio calculated based on the formula of the intended doped manganese-rich cathode active material, were mixed to form a first mixture. The first mixture was heated to a first temperature of about 800° C. with a heating speed of 3° C./min and sintered at the first temperature for about 5 hours in air. The sintered first mixture was cooled down to room temperature. The sintered first mixture was mixed with a metal dopant source such as Na₂CO₃ with a molar ratio calculated based on the formula of the intended doped manganese-rich cathode active material to form a second mixture. The second mixture was heated to a second temperature of 700° C., lower than the first temperature, with a beating speed of 3° C./min and sintered at the second temperature for about 5 hours in air. The sintered second mixture was then cooled down to room temperature and then was sieved.

In this example, Li₂CO₃, Mn₃O₄, Al(OH)₃, H₃BO₃ and MnF₂ were first mixed to form the first mixture and heated to 800° C. with a heating speed of 3° C./min and sintered at 800° C. for about 5 hours in air. The sintered first mixture was then mixed with Na₂CO₃ to form the second mixture and was heated to 700° C. with a heating speed of 3° C./min and sintered at 700° C. for about 5 hours in air. The sintered second mixture was then sieved to produce the MnF₂/Na₂CO₃ doped Mn-rich cathode active material.

Other doped manganese-rich cathode active material, including NaF/Na₂CO₃-doped Mn-rich cathode active materials were also prepared using the two-step baking method by replacing the anion dopant source MnF₂ with MgF₂ or NaF.

The produced doped manganese-rich cathode active material had a formula of Li_{1.05}Na_{0.05}Mn_{1.82}Al_{0.15}B_{0.03}O_{3.98}F_{0.02}.

### Example 2—Single-Step Baked Active Material and Electrochemical Cell

The doped manganese-rich cathode active materials were prepared utilizing methods similar to the single-step baking method described in Example 1. Cathode electrodes were prepared by providing the doped manganese-rich cathode active materials, and the doped manganese-rich cathode active materials were mixed with polyvinylidene difluoride (PVDF) and Super-S carbon black at a ratio of 95:2.5:2.5 wt. % in N-methyl-2-pyrrolidone (NMP) to form a slurry. The slurry was cast onto a piece of aluminum foil which then dried in an oven at 120° C. for 3 hours. The dried slurry was then calendered at a pressure of 2000 atm to form a bulk electrode material with a loading of 30 mg/cm². 5.3×5.3 cm pouch cell electrodes were punched from the bulk electrode material and the electrodes were dried under vacuum at 120° C. for 14 hours.

The anode electrodes were prepared by mixing the anode active material, carboxymethyl cellulose (CMC) and styrene-butadiene rubber (SBR) at a ratio of 97:1.5:1.5 wt. % to form a slurry. The slurry was cast onto a piece of copper foil which then was dried in an oven at 80° C. for 3 hours. The dried slurry was then calendered at a pressure of 2000 atm to form a bulk electrode material with a loading of 10 mg/cm². 5.5×5.5 cm pouch cell electrodes were punched from the bulk electrode material and the electrodes were dried under vacuum at 80° C. for 14 hours.

Full cells (i.e., pouch cells) with cathode electrodes comprising the doped manganese-rich cathode active materials were prepared and tested. The cathode electrodes for the full cells were prepared similarly to the methods described above. Full cells were prepared by stacking a cathode electrode, a separator, and an anode electrode together to form an electrode stack. The electrode stack was placed in a pouch which was filled with a lithium hexafluorophosphate electrolyte solution. The electrolyte is formed by dissolving 1.2 M a lithium hexafluorophosphate electrolyte in an EC/DMC solution with a 3:7 ratio.

The full cells were maintained at 55° C. during testing. The full cells were initially charged to 1.7 V at a constant rate of C/20 and held for 4 hours, then charged to 4.05 V at a constant rate of C/5 and rest for 12 hours, and then charged to 4.2 V at a rate of C/20 and discharged to 2.5 V at a rate of C/20. The full cell is considered “formed” after these initial charge and discharge steps. Afterwards, a reference performance test (RPT) was carried out. The full cell was charged to 4.2V at a rate of C/20, and then discharged to 2.5 V. Then, the full cell was charged to 4.2 V at a rate of C/2. Then, the direct current resistance (DCR) was checked every 10% of the stage of charge (“SOC”) for 30 seconds with a C/2 discharge pulse, 5 minutes rest time to 3.0 V. Then the full cells were cycled between 2.85-4.20 V at a constant rate of C/3.

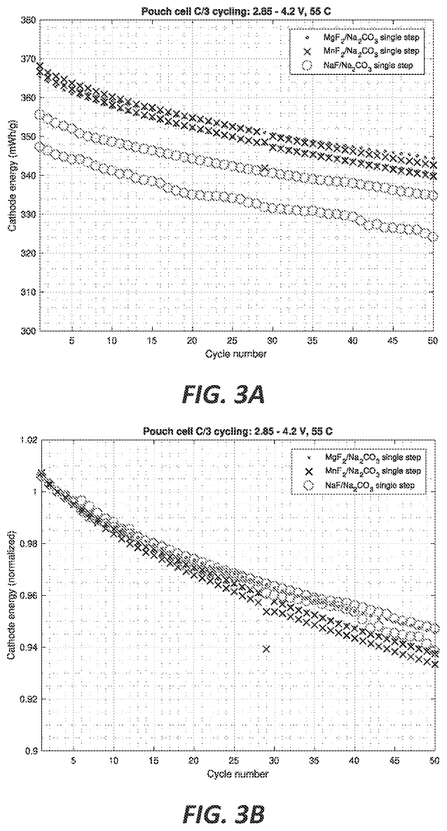

FIGS. 3A and 3B are plots showing the actual and normalized cycle performances of the full cells comprising MgF₂/Na₂CO₃-doped, MnF₂/Na₂CO₃-doped and NaF/Na₂CO₃-doped LiMn₂O₄ cathode active material prepared with the single-step baking method disclosed herein. As can be seen in FIG. 3A, the initial average capacity for all the doped LiMn₂O₄ cathode active material is more than 345 mWh/g. The initial capacity for MnF₂/Na₂CO₃-doped LiMn₂O₄ cathode active material is more than 365 mWh/g. As can be seen in FIGS. 3A and 3B, the energy retention for all the doped LiMn₂O₄ cathode active material after 50 cycles is more than 93%. The average energy retention for the NaF/Na₂CO₃-doped LiMn₂O₄ cathode active material after 50 cycles is more than 94%.

### Example 3—Two-Step Baked Active Material and Electrochemical Cell

The doped manganese-rich cathode active materials were prepared utilizing the methods similar to the two-step baking method described in Example 1. Cathode electrodes were prepared utilizing the methods similar to the methods described in Example 2.

Full cells (i.e., pouch cells) with cathode electrodes comprising the doped manganese-rich cathode active materials formed with two-step baking methods were prepared and tested utilizing the methods and testing conditions similar to the methods described in Example 2.

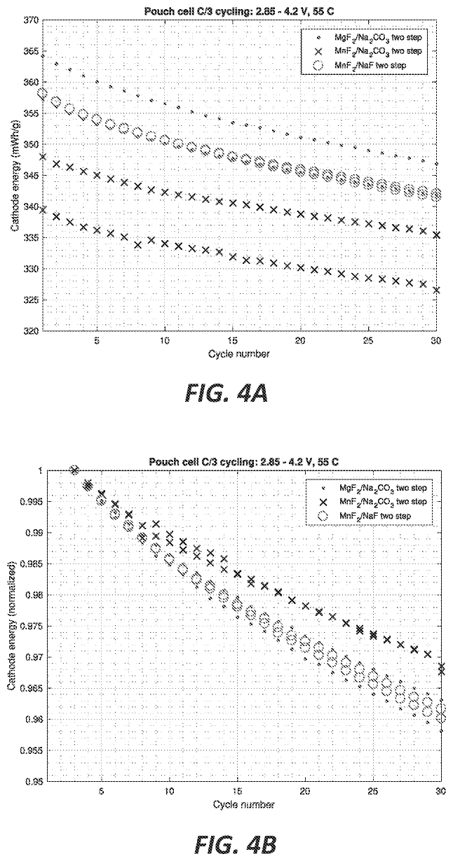

FIGS. 4A and 4B are plots showing the actual and normalized cycle performances of the full cells comprising MgF₂/Na₂CO₃-doped, MnF₂/Na₂CO₃-doped and NaF/Na₂CO₃-doped LiMn₂O₄ cathode active material prepared with two-step baking method. As can be seen in FIG. 4A, the average initial capacity for all the doped LiMn₂O₄ cathode active material is more than 340 mWh/g. The average initial energy for MgF₂/Na₂CO₃-doped LiMn₂O₄ cathode active material is more than 355 mWh/g. As can be seen in FIGS. 4A and 4B, the average energy retention for all the doped LiMn₂O₄ cathode active material after 30 cycles is more than 96%. The average energy retention for the MnF₂/Na₂CO₃-doped LiMn₂O₄ cathode active material after 30 cycles is more than 96.5%.

### Example 4—Doped and Control Cathode Active Material Electrochemical Cell

The doped manganese-rich cathode active materials were prepared utilizing the methods similar to those described in Example 1. The control cathode active material is Al and B doped LiMn₂O₄ with a formula of Li_{1.11}Mn_{1.88}Al_{0.088}B_{0.024}O₄. Cathode electrodes were prepared utilizing the methods similar to the methods described in Example 2 with the halogen-doped manganese-rich cathode active materials and the control cathode active material.

Full cells (i.e., pouch cells) comprising the doped manganese-rich cathode active materials and the control cathode active material were prepared and tested utilizing the methods and testing conditions similar to the methods described in Example 2.

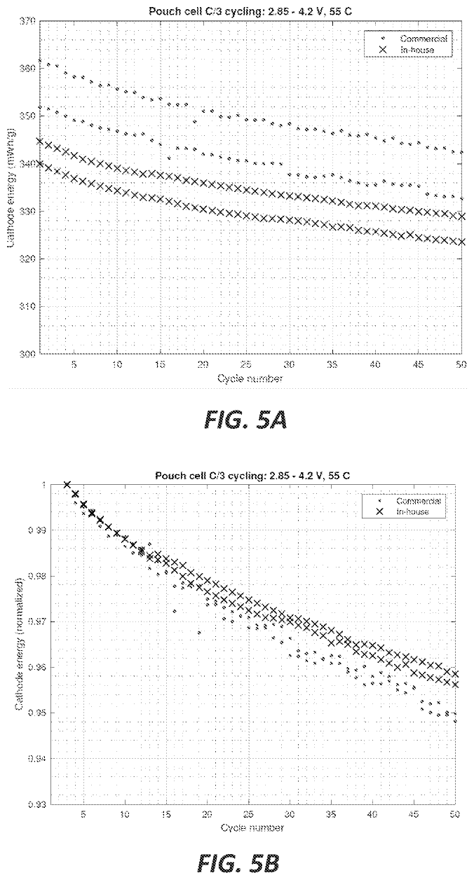

FIGS. 5A and SB are plots showing the actual and normalized cycle performances of the full cells comprising MnF₂/Na₂CO₃-doped LiMn₂O₄ cathode active material (labeled “In-house”) and control cathode active material (labeled “Commercial”). As can be seen in FIGS. 5A and 5B, the energy retention of the cell with the MnF₂/Na₂CO₃-doped LiMn₂O₄ cathode active material after 50 cycles is higher than that of the cell with the control cathode active material. Thus, the doped Mn-rich cathode active material shows an improved energy retention and prolonged cycle life compared to a Mn-rich cathode active material without the metal and anion dopants.

### Example 5—Measurement of Manganese Dissolution

The doped manganese-rich cathode active materials were prepared utilizing the methods similar to those described in Example 1. The control cathode active material is Al and B doped LiMn₂O₄ with a formula of Li_{1.11}Mn_{1.88}Al_{0.088}B_{0.024}O₄. The cathode electrodes were prepared utilizing the methods similar to the methods described in Example 2 with the doped manganese-rich cathode active materials and the control cathode active material.

Full cells (i.e., pouch cells) with cathode electrodes comprising the doped manganese-rich cathode active materials and the control cathode active material were prepared utilizing the methods similar to the methods described in Example 3. The full cells were formed at 55° C.

After the formation, the full cells were dissembled and the amount of Mn deposited on the anodes was measured with inductively coupled plasma mass spectrometry (ICP-MS). The amount of Mn on the anodes of the cells with different cathode active materials after being normalized to the total amount of LMO in the pouch cell are listed in Table 1. The amount of Mn on the anodes of the cells with the doped cathode active materials formed by the single-step baking method using MgF₂ and Na₂CO₃ as the dopant sources, using MnF₂ and Na₂CO₃ as the dopant sources, and using NaF and Na₂CO₃ as the dopant sources is 227, 161 and 167 ppm for every gram of LiMn₂O₄, respectively. The amount of Mn on the anodes of the cells with the doped cathode active materials formed by the two-step baking method using MgF₂ and Na₂CO₃ as the dopant sources and using MnF₂ and Na₂CO₃ as the dopant sources is 165 and 128 ppm for every gram of LiMn₂O₄, respectively. In contrast, the amount of Mn on the anode of the cell using control cathode active material is about 231 ppm for every gram of LiMn₂O₄. Thus, Mn dissolution is greatly reduced using the doped cathode active material disclosed herein.

The reduced amount of Mn measured on the anode of the cell demonstrates the reduced Mn dissolution from the spinel LiMn₂O₄ (LMO) cathode active material. Such reduced Mn dissolution from the spinel LiMn₂O₄ may help reduce the risk of soft short during formation and cycling of the cells. The reduced Mn dissolution may also help improve the cycle life.

TABLE 1

| | Mn ppm/g | | |
|---|---|---|---|
| Test | LiMn₂O₄ | Active Cathode | Processing |
| # | (LMO) | Material | Methods |
| 1 | 231 | Control cathode active | / |
| | | material | |
| 2 | 227 | MgF₂, Na₂CO₃ doped | Single-step |
| | | cathode active | |
| | | material | |
| 3 | 161 | MnF₂, Na₂CO₃ doped | Single-step |
| | | cathode active | |
| | | material | |
| 4 | 167 | NaF, Na₂CO₃ doped | Single-step |
| | | cathode active | |
| | | material | |
| 5 | 165 | MgF₂, Na₂CO₃ doped | Two-step |
| | | cathode active | |
| | | material | |
| 6 | 128 | MnF₂, Na₂CO₃ doped | Two-step |
| | | cathode active | |
| | | material | |

While certain embodiments have been described, these embodiments have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

1. A doped cathode active material, comprising a compound having the chemical formula: 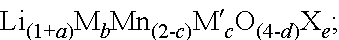
wherein:
M is a metal dopant;
M′ is a Group 13 dopant;
X is an anion dopant;
a is a value from 0 to 0.2;
b is a value from 0.01 to 0.1;
c is a value from 0 to 0.2;
d is a value from 0 to 0.04; and
e is a value from 0.001 to 0.04.

2. The doped cathode active material of claim 1, wherein M is selected from the group consisting of K, Na, Mg, Sr, and combinations thereof.

3. The doped cathode active material of claim 1 or 2, wherein X is a halogen dopant.

4. The doped cathode active material of claim 1, wherein X is selected from the group consisting of F, Cl, SO₄, and combinations thereof.

5. The doped cathode active material of claim 1, wherein M′ is selected from the group consisting of B, Al, and combinations thereof.

6. The doped cathode active material of claim 1, wherein M′_{c} is AlₓB_{y}, where c=x+y.

7. The doped cathode active material of claim 6, wherein the compound has a chemical formula Li₍₁₊ₐ₎Na_{b}Mn_{(2-c)}AlₓB_{y}O_{(4-d)}Fₑ.

8. The doped cathode active material of claim 7, wherein the compound has a chemical formula Li_{1.05}Na_{0.05}Mn_{1.82}Al_{0.15}B_{0.03}O_{3.98}F_{0.02}.

9. A cathode electrode film, comprising the doped cathode active material of claim 1 and a binder.

10. A cathode electrode, comprising the cathode electrode film of claim 9 disposed over a current collector.

11. An energy storage device, comprising:
the cathode electrode of claim 10;
a separator;
an anode electrode;
an electrolyte; and
a housing,
wherein the cathode electrode, the separator, and the anode electrode are positioned within the housing.

12. The energy storage device of claim 11, wherein the energy storage device is a battery.

13. A process of forming a doped cathode active material, comprising:
combining a manganese source, a dopant material, and a lithium source to form a doped cathode active material mixture; and
heating the doped cathode active material mixture to form a doped cathode active material.

14. The process of claim 13, wherein the lithium source is selected from the group consisting of LiOH, Li₂CO₃, LiF, LiCl, and combinations thereof.

15. The process of claim 13, wherein the manganese source is selected from the group consisting of Mn₃O₄, MnF₂, and combinations thereof.

16. The process of claim 13, wherein the dopant material is selected from the group consisting of a Group 13 dopant source, a metal dopant source, an anion dopant source, and combinations thereof.

17. The process of claim 16, wherein the anion dopant source is selected from the group consisting of MnF₂, MgF₂, MgCl₂, AlF₃, SrF₂, NaF, NaCl, LiF, LiCl, KCl, K₂SO₄, and combinations thereof.

18. The process of claim 16, wherein the metal dopant source is selected from the group consisting of KCl, K₂SO₄, NaF, NaCl, Na₂CO₃, MgF₂, MgCO₃, Mg(OH)₂, SrF₂, MgCl₂, and combinations thereof.

19. The process of claim 16, wherein the Group 13 dopant source is selected from the group consisting of H₃BO₃, Al(OH)₃, and combinations thereof.

20. The process of claim 13, wherein the dopant material comprises H₃BO₃, Al(OH)₃, MnF₂ and Na₂CO₃.

21. The process of claim 13, wherein the doped cathode active material mixture is heated to about 700° C.-900° C.

22. The process of claim 13, wherein the doped cathode active material mixture is heated for about 4-6 hours in ambient air.

23. A process of forming a doped cathode active material, comprising:
combining a manganese source, a first dopant material, and a lithium source to form a first doped cathode active material mixture;
heating the first doped cathode active material mixture at a first temperature;
combining the heated first doped cathode active material mixture with a second dopant material to form a second doped cathode active material mixture; and
heating the second doped cathode active material mixture at a second temperature different from the first temperature to form the doped cathode active material.

24. The process of claim 23, wherein the first dopant material is selected from the group consisting of a Group 13 dopant source, an anion dopant source, and combinations thereof.

25. The process of claim 23, wherein the second dopant material comprises a metal dopant source.

26. The process of claim 23, wherein the second temperature is lower than the first temperature.

27. The process of claim 23, wherein the first temperature is about 700° C.-900° C.

28. The process of claim 23, wherein the second temperature is about 600° C.-800° C.

29. The process of claim 23, further comprising sieving the heated second doped cathode active material mixture.
